(19) United States
(12) Patent Application Publication
(10) Pub. No.: US 2020/0271032 A1
(43) Pub. Date: Aug. 27, 2020

(54) METHOD FOR OPERATING AN EXHAUST GAS AFTERTREATMENT SYSTEM OF AN INTERNAL COMBUSTION ENGINE, AN EXHAUST GAS AFTERTREATMENT SYSTEM FOR AN INTERNAL COMBUSTION ENGINE, AND AN INTERNAL COMBUSTION ENGINE COMPRISING SUCH AN EXHAUST GAS AFTERTREATMENT SYSTEM

(71) Applicant: MTU FRIEDRICHSHAFEN GMBH, Friedrichshafen (DE)

(72) Inventors: Klaus RUSCH, Achberg (DE); Julian Nicolaas BÄR, Meckenbeuren (DE)

(21) Appl. No.: 16/461,958

(22) PCT Filed: Nov. 3, 2017
(86) PCT No.: PCT/EP2017/001282

§ 371 Date: May 17, 2019

(30) Foreign Application Priority Data
Nov. 18, 2016 (DE) 10 2016 222 801.3

(51) Int. Cl. F01N 3/20; F01N 11/00; F02B 37/16; F02B 37/18; F01N 9/00

(52) U.S. Cl. CPC F01N 3/208; F01N 2900/1404; F02B 37/162; F02B 37/18; F01N 9/005; F01N 2550/02; F01N 2560/026; F01N 2560/021; F01N 2560/06; F01N 2610/02; F01N 2610/146; F01N 2900/0416; F01N 2900/0418; F01N 2900/1402; F01N 11/002

(57) ABSTRACT

This version will replace all prior versions in the application: A method for operating an exhaust gas aftertreatment system of an internal combustion engine, wherein at least one operating parameter is detected during the operation of the exhaust gas aftertreatment system, the operating parameter being associated with an oxidation state of an SCR catalyst material of the exhaust gas aftertreatment system, and at least one measure for preventing an ongoing reduction of the SCR catalyst material and/or at least one reoxidizing measure for reoxidizing the SCR catalyst material is introduced in accordance with the at least one operating parameter.

The invention relates to a method for operating an exhaust gas aftertreatment system of an internal combustion engine, to an exhaust gas aftertreatment system for an internal combustion engine, and to an internal combustion engine having an exhaust gas aftertreatment system of this type.

In particular in the case of internal combustion engines which are used in the non-road or off-road area and/or are used at least substantially at stationary operating points, it has been shown that a nitrogen oxide conversion rate on an SCR catalytic converter material of an exhaust gas aftertreatment system which is used for an internal combustion engine of this type decreases over time, in particular after relatively long full load operation. In order to compensate for this, internal combustion engines of this type are either tuned to lower nitrogen oxide emissions, which leads, however, to a reduced fuel efficiency, or they are equipped with larger, heavier and, in particular, more voluminous SCR catalytic converters, which is expensive, unfavorable in relation to an exhaust gas back pressure for the internal combustion engine, and intensive in terms of installation space.

The invention is based on the object of providing a method for operating an exhaust gas aftertreatment system of an internal combustion engine, of providing an exhaust gas aftertreatment system for an internal combustion engine, and of providing an internal combustion engine having an exhaust gas aftertreatment system of this type, the stated disadvantages not occurring.

The object is achieved by the subjects of the independent claims being provided. Advantageous refinements result from the subclaims.

The object is achieved, in particular, by a method for operating an exhaust gas aftertreatment system of an internal combustion engine being provided, in the case of which method at least one operating parameter is detected during operation of the exhaust gas aftertreatment system, which operating parameter is associated with an oxidation state of an SCR catalytic converter material of the exhaust gas aftertreatment system, at least one reoxidation measure for the reoxidation of the SCR catalytic converter material being initiated in a manner which is dependent on the at least one operating parameter. As an alternative or in addition to the initiation of a reoxidation measure, at least one measure which suppresses a progressing or further reduction of the catalytic converter material can be initiated in a manner which is dependent on the at least one operating parameter. It has been recognized to this extent within the context of the invention that the decreasing nitrogen oxide conversion rate can be attributed, in particular, to a reduction of the SCR catalytic converter material, which reduction takes place precisely at a high exhaust gas temperature and a high reducing agent metering rate, as a competing reaction to the reduction of nitrogen oxides, the SCR catalytic converter material only being capable to a reduced extent or no longer being capable in the reduced state of catalyzing the reduction of nitrogen oxides. A reoxidation of the SCR catalytic converter material takes place under the abovementioned operating conditions only very slowly, with the result that the SCR catalytic converter material is scarcely regenerated or is not regenerated at all in said circumstances. This effect occurs, in particular, in the case of non-road or off-road applications of internal combustion engines, in particular if they are operated at stationary operating points and very particularly during full load operation. In the on-road area, in contrast, the effect typically occurs to a greatly reduced extent or even does not occur at all, since, in particular, the exhaust gas temperature fluctuates to a more pronounced extent and does not remain at high values for a relatively long time. At the same time, a reducing agent metering rate also typically fluctuates to a greater extent in the case of on-road applications than in the case of off-road applications. A reduction of the nitrogen oxide conversion rate on the SCR catalytic converter material can then be counteracted in an advantageous way if an oxidation state of the SCR catalytic converter material is monitored with the aid of the at least one operating parameter, at least one reoxidation measure for the reoxidation of the SCR catalytic converter material being initiated and/or at least one further reduction of the SCR catalytic converter material being prevented in a manner which is dependent on said operating parameter. In this way, the catalytic converter material can preferably be regenerated in an active manner, and its conversion rate can be increased again, or the trend toward a lower conversion rate can at least be stopped. This in turn allows the use of smaller, inexpensive SCR catalytic converters which save installation space, and/or tuning of an internal combustion engine which is used with the exhaust gas aftertreatment system toward higher nitrogen oxide emissions and therefore at the same time toward a higher degree of efficiency. Here, limit values which apply to the nitrogen oxide emissions can nevertheless be complied with on account of the conversion rate of the SCR catalytic converter material, which conversion rate is increased or at least does not decrease further. The increased degree of efficiency of the internal combustion engine in turn has a fuel-saving effect.

The at least one reoxidation measure and/or the at least one measure for preventing further reduction are/is initiated, in particular, if the at least one operating parameter is indicative of an oxidation state of the SCR catalytic converter material, which oxidation state has the consequence of a reduced (preferably in a predefined way) conversion of nitrogen oxides on the SCR catalytic converter material. In this way, the SCR catalytic converter material can be reoxidized as needed and therefore regenerated.

As an alternative to and/or in combination with immediate starting of a measure after the initiation thereof, a measure of this type can also first of all be merely requested by way of the initiation and can then not be carried out until operational and/or engine-based boundary conditions favor the success of the measure. An initiation of a measure can therefore be understood to mean that it is started immediately, or else that the measure is requested and is started with a delay or a temporal offset from its request.

An oxidation state of the SCR catalytic converter material is understood to mean, in particular, the oxidation state of a surface of the SCR catalytic converter material. It is shown here that customary SCR catalytic converter materials are typically present in an oxidized state, for example vanadium pentoxide, oxygen atoms which are arranged on the surface of the SCR catalytic converter material contributing to the catalysis of the reduction of nitrogen oxides. If the SCR catalytic converter material is reduced, oxygen atoms of this type are removed, with the result that the catalytic efficiency of the SCR catalytic converter material drops.

It is provided according to one development of the invention that an exhaust gas temperature (in particular, upstream of the SCR catalytic converter material, preferably directly upstream thereof, or on the SCR catalytic converter material) is detected as the at least one operating parameter. As an alternative or in addition, an operating time is preferably detected as the at least one operating parameter, preferably measured since a last reoxidation measure or since a start of the internal combustion engine. It is also possible that an operating time of the internal combustion engine in a defined operating state or in a defined engine map region is detected. An initiation of the at least one measure for preventing further reduction and/or the at least one reoxidation measure can take place to this extent, in particular, in a temperature-controlled and/or time-controlled manner. It is shown here that a reduction of the SCR catalytic converter material occurs, in particular, at high exhaust gas temperatures and/or relatively long operating times, in particular at high load points, particularly in the case of full load.

As an alternative or in addition, it is possible that an exhaust gas temperature/operating time integral is detected as the at least one operating parameter. To this extent, an oxidation state of the SCR catalytic converter material depends, in particular, on the time for which, and the exhaust gas temperature at which, the exhaust gas aftertreatment system is operated, the operating time and the exhaust gas temperature together fixing an operating history which overall determines the oxidation state.

As an alternative or in addition, it is possible that a nitrogen oxide load which is to be converted in a temporally integral manner, that is to say an overall quantity of nitrogen oxide which is fed to the SCR catalytic converter material over an integration time and is converted on said SCR catalytic converter material, or a temporarily integrally metered reducing agent quantity, that is to say a quantity of reducing medium which is metered in overall over an integration time, is detected as the at least one operating parameter.

As an alternative or in addition, a nitrogen oxide concentration and/or a reducing agent concentration downstream of the SCR catalytic converter material in the exhaust gas aftertreatment system are/is detected as the at least one operating parameter. The nitrogen oxide concentration and/or the reducing agent concentration are/is particularly preferably detected directly downstream of the SCR catalytic converter material. Ammonia is preferably used as reducing agent, with the result that, in particular, an ammonia concentration is detected (preferably directly) downstream of the SCR catalytic converter material. Both the nitrogen oxide concentration and the ammonia concentration are indicators for an oxidation state of the SCR catalytic converter material, in particular since a high nitrogen oxide concentration can firstly (just like a high reducing agent concentration) promote a reduction of the catalytic converter material as a competing reaction to the reduction of nitrogen oxides, a high nitrogen oxide concentration also indicating a reduced nitrogen oxide conversion rate on the SCR catalytic converter material. An overall nitrogen oxide concentration of nitrogen monoxide and nitrogen dioxide is preferably determined by way of a nitrogen oxide sensor upstream of the SCR catalytic converter material, a reducing agent concentration, in particular an ammonia concentration, being determined downstream of the SCR catalytic converter material by way of a reducing agent sensor, in particular an ammonia sensor.

It is provided according to one development of the invention that the at least one operating parameter is compared with a predefined threshold value, the at least one reoxidation measure and/or the at least one measure for preventing a further reduction being initiated if the at least one operating parameter reaches or exceeds the predefined threshold value. The threshold value can be, in particular, an exhaust gas temperature threshold, an operating time threshold, an exhaust gas temperature/operating time integral threshold, a threshold for the integral nitrogen oxide load, a threshold for the integral reducing agent quantity, a nitrogen oxide concentration threshold and/or a reducing agent concentration threshold. Here, the term “exceed” is used in a general sense for the predefined threshold value being exceeded in the positive or negative direction, depending on the definition of the operating parameter firstly and the threshold value secondly. At any rate, the exceeding of the predefined threshold value by way of the operating parameter points in the direction of an increased reduction of the SCR catalytic converter material, with the result that, in this case, the initiation of a measure for preventing further reduction and/or the performance of the reoxidation measure are/is appropriate.

In particular, a value of 400° C. can be used as threshold value for the exhaust gas temperature. A reduction of the SCR catalytic converter material impends, in particular, when the exhaust gas temperature is higher than 400° C. for a relatively long time. In particular, from at least one hour to at most 10 hours, preferably 4 hours, can be used as operating time threshold.

As an alternative, it is possible that the at least one measure for preventing further reduction and/or the at least one reoxidation measure are/is initiated if the at least one operating parameter reaches or exceeds the predefined threshold value for a predefined time duration. This can take into consideration the aspect that the reduction of the SCR catalytic converter material proceeds in a particularly unfavorable way when the threshold value is reached or exceeded for a relatively long time. In the case of the determination of whether the at least one measure for preventing further reduction and/or the at least one reoxidation measure are/is initiated, pauses are preferably taken into consideration in the form of operating states, in which the operating parameter does not reach or exceed the predefined threshold value. It is possible here that the detected time is reset from a predefined pause length and is detected again by way of the at least one operating parameter in the case of a subsequent renewed exceeding or reaching of the predefined threshold value. This takes into account the fact that a regeneration of the SCR catalytic converter material without an active reoxidation measure is possible in the pauses.

It is provided according to one development of the invention that the oxidation state and/or a nitrogen oxide conversion value of the SCR catalytic converter material are/is calculated by means of a catalytic converter reaction model. The catalytic converter reaction model is fed the at least one operating parameter as an input variable. The at least one measure for preventing further reduction and/or the at least one reoxidation measure are/is initiated in a manner which is dependent on the oxidation state which is determined by way of the catalytic converter reaction model and/or the nitrogen oxide conversion value which is determined by way of the catalytic converter reaction model.

Here, a nitrogen oxide conversion value is understood to mean, in particular, an absolute nitrogen oxide conversion, in particular an absolute nitrogen oxide conversion rate, or, as an alternative, a reduction of a nitrogen oxide conversion or a nitrogen oxide conversion rate on account of a reduction of the SCR catalytic converter material.

Catalytic converter reaction models are well known, for example from the following citations:

[1] Massimo Colombo, Isabella Nova, Enrico Tronconi, Volker Schmeißer, Brigitte Bandl-Konrad, Lisa Zimmermann (2012), NO/NO2/N2O—NH3 SCR reactions over a commercial Fe-zeolite catalyst for diesel exhaust aftertreatment: Intrinsic kinetics and monolith converter modelling, Applied Catalysis B: Environmental, Volumes 111-112, Pages 106-118, http://dx.doi.org/10.1016/j.apcatb.2011.09.023;

[2] Nova, I., Ciardelli, C., Tronconi, E., Chatterjee, D. and Bandl-Konrad, B. (2006), NH₃-SCR of NO over a V-based catalyst: Low-T redox kinetics with NH₃ inhibition. AIChE Journal, Volume 52, Pages 3222-3233, doi:10.1002/aic.10939.

Here, they can be, in particular, what are known as global kinetic SCR models. They can advantageously be extended by further global kinetic reactions which comprise the oxidation state of the SCR catalytic converter material. A model which results in this way can then calculate the oxidation state to be expected of the catalytic converter surface and/or its negative effect on the nitrogen oxide conversion from the operating history of the exhaust gas aftertreatment system, and can be used for the question as to whether the at least one measure for preventing further reduction and/or the at least one reoxidation measure are/is to be initiated. U.S. Pat. No. 8,474,248 B2, for example, describes a model-based control strategy for controlling for a defined catalytic converter age. Within the context of the invention, a control strategy for the oxidation state of the SCR catalytic converter material can be provided in an analogous way, said oxidation state being independent of the catalytic converter age.

It is provided according to one development of the invention that metering of a reducing agent into an exhaust gas path of the exhaust gas aftertreatment system upstream of the SCR catalytic converter material (preferably in a temporally limited manner) is reduced as the at least one measure for preventing further reduction and/or as the at least one reoxidation measure. This can take place, for example, for a time which is required to reach a thermally steady state of the SCR catalytic converter material over the entire catalytic converter. The reduction of the reducing agent metering can be carried out, for example, for from at least one minute to at most 60 minutes, preferably for 15 minutes. As a result of the reduction of the reducing agent metering, the reducing agent oxidation as a competing reaction to the reoxidation of the SCR catalytic converter material is suppressed.

Said measure can be combined, for example, with an operating time threshold in such a way that the reduction of the reducing agent metering is carried out for approximately 15 minutes if a continuous stationary operation above a defined exhaust gas temperature threshold has previously been determined for, in particular, from at least one hour to at most 10 hours, preferably for 4 hours.

As an alternative or in addition, an oxygen concentration in the exhaust gas upstream of the SCR catalytic converter material is preferably raised as the at least one measure for preventing further reduction and/or the at least one reoxidation measure. The reoxidation of the SCR catalytic converter material can be promoted by way of a higher oxygen content in the exhaust gas.

As an alternative or in addition, the exhaust gas temperature upstream of the SCR catalytic converter material is preferably lowered as the at least one measure for preventing further reduction and/or the at least one reoxidation measure. The reoxidation of the SCR catalytic converter material can be promoted by way of a lower temperature in the exhaust gas.

As an alternative or in addition, a nitrogen oxide concentration in the exhaust gas upstream of the SCR catalytic converter material is preferably reduced as the at least one measure for preventing further reduction and/or as the at least one reoxidation measure. Said measure has, in particular, the effect per se that a reducing agent metering control reduces the metering of the reducing agent if less nitrogen oxide is present in the exhaust gas upstream of the SCR catalytic converter material. Furthermore, a reduction of the nitrogen monoxide concentration in the region of the SCR catalytic converter material leads to a suppression of the oxidation of nitrogen monoxide to form nitrogen dioxide as a competing reaction to the reoxidation of the SCR catalytic converter material. The nitrogen oxide concentration in the exhaust gas can also be carried out, however, in a flanking manner with respect to the reduction of the reducing agent metering, in order for it to be possible for predefined nitrogen oxide limit values for the nitrogen oxide emission to be maintained even in the case of reduced reducing agent metering. In order to reduce the nitrogen oxide concentration in the exhaust gas, engine-internal measures, in particular, are worth considering in the case of an internal combustion engine which is operated together with the exhaust gas aftertreatment system.

It is provided according to one development of the invention that the oxygen concentration in the exhaust gas upstream of the SCR catalytic converter material is raised and/or the exhaust gas temperature is lowered, by an actuating position of a turbine bypass path actuating device for a bypass path of an exhaust gas turbocharger turbine upstream of the SCR catalytic converter material being changed. A turbine bypass path actuating device of this type can preferably be configured as what is known as a wastegate, and can comprise a valve device or an exhaust gas flap. If the turbine bypass path actuating device is closed further or completely, more exhaust gas is conducted via the exhaust gas turbocharger turbine, with the result that the performance of an exhaust gas turbocharger compressor which is operatively connected to the exhaust gas turbocharger turbine is increased at the same time, and more combustion air is thus conveyed into a combustion chamber of the internal combustion engine. As a result, a higher combustion air/fuel ratio is achieved in the combustion chamber, which ultimately also results in an increased oxygen partial pressure in the exhaust gas. It is also possible, however, that the turbine bypass path actuating device is opened further in defined operating states of the exhaust gas turbocharger, in particular in order to prevent compressor surging and to increase the degree of efficiency of the exhaust gas turbocharger. This can also contribute to the increase of the oxygen partial pressure in the exhaust gas and/or lower the exhaust gas temperature.

As an alternative or in addition, it is possible that the oxygen concentration in the exhaust gas upstream of the SCR catalytic converter is raised and/or the exhaust gas temperature is lowered, by an actuating position of the compressor bypass path actuating device for a bypass path of an exhaust gas turbocharger compressor which is preferably arranged in the charging path of an internal combustion engine which has the exhaust gas aftertreatment system is changed. Here, the compressor bypass path actuating device can be opened, in particular, for the removal of charge air, with the result that the compressor is bypassed. As a result, the degree of efficiency of the exhaust gas turbocharger can be increased in defined operating ranges, in particular if compressor surging would otherwise occur. The advantageous effect on the combustion air/fuel ratio by way of the increased degree of efficiency exceeds the negative effect of the compressor bypassing here.

If more combustion air is fed to the combustion chamber of the internal combustion engine, the exhaust gas temperature can be lowered at the same time and the nitrogen oxide concentration in the exhaust gas can be reduced.

It is provided according to one development of the invention that the nitrogen oxide concentration in the exhaust gas upstream of the SCR catalytic converter material is reduced, by an exhaust gas recirculation rate for the recirculation of exhaust gas into a combustion chamber of the internal combustion engine which is assigned to the exhaust gas aftertreatment system being increased. As a result, in particular, the combustion chamber temperature can be lowered, and the nitrogen oxide emissions can be lowered.

As an alternative or in addition, it is preferably provided that the nitrogen oxide concentration in the exhaust gas upstream of the SCR catalytic converter material is reduced, by a location of the center of combustion in the combustion chamber of the internal combustion engine which is assigned to the exhaust gas aftertreatment system being changed. This can be brought about, in particular, via a shift of an ignition time. Here, the ignition time and/or the location of the center of combustion are/is shifted, in particular, in such a way that the nitrogen oxide emissions are reduced, for example by way of a retarding adjustment of the ignition time.

The object is also achieved by an exhaust gas aftertreatment system for an internal combustion engine being provided, which exhaust gas aftertreatment system has an exhaust gas path, an SCR catalytic converter being arranged in the exhaust gas path. Moreover, the exhaust gas aftertreatment system has a reducing means metering device which is set up to meter a reducing agent into the exhaust gas path upstream of the SCR catalytic converter. The reducing agent can be, in particular, ammonia or an ammonia precursor product, in particular a urea/water solution. Moreover, the exhaust gas aftertreatment system has at least one detection device which is set up to detect at least one operating parameter which is associated with an oxidation state of an SCR catalytic converter material of the SCR catalytic converter. The exhaust gas aftertreatment system has a control device which is set up to initiate at least one measure for preventing further reduction and/or at least one reoxidation measure for the reoxidation of the SCR catalytic converter material in a manner which is dependent on the at least one operating parameter. In conjunction with the exhaust gas aftertreatment system, the advantages, in particular, which have already been described in conjunction with the method result.

The at least one detection device can be, in particular, an exhaust gas temperature sensor, an operating time detection means, an exhaust gas temperature/operating time integral detection means, a nitrogen oxide sensor and/or a reducing agent sensor, in particular an ammonia sensor. It is possible, in particular, that the exhaust gas aftertreatment system has a nitrogen oxide sensor and/or an exhaust gas temperature sensor upstream of the SCR catalytic converter. As an alternative or in addition, it is possible that the exhaust gas aftertreatment system has a reducing agent sensor, in particular an ammonia sensor, and/or a nitrogen oxide sensor and/or a temperature sensor downstream of the SCR catalytic converter.

At least one predefined threshold value is preferably stored in the control device, with which threshold value the at least one operating parameter is compared, in order to initiate the at least one measure for preventing further reduction and/or the at least one reoxidation measure in a manner which is dependent on the comparison.

A catalytic converter reaction model is particularly preferably stored in the control device, which catalytic converter reaction model can be fed the at least one operating parameter as an input variable, the at least one measure for preventing further reduction and/or the at least one reoxidation measure being initiated in a manner which is dependent on an oxidation state which is determined by way of the catalytic converter reaction model and/or a nitrogen oxide conversion value which is determined by way of the catalytic converter reaction model.

The control device is preferably operatively connected to the reducing agent metering device, in order to actuate the latter, in particular, in order to set a reducing agent metering rate. As an alternative or in addition, the control device is preferably set up to actuate a turbine bypass path actuating device and/or a compressor bypass path actuating device of an internal combustion engine which has the exhaust gas aftertreatment system, said control device preferably being operatively connected to at least one of said devices. In addition or as an alternative, the control device is preferably set up to set an exhaust gas recirculation rate and/or a location of the center of combustion for at least one combustion chamber of the internal combustion engine.

Finally, the object is also achieved by an internal combustion engine being provided which has an exhaust gas aftertreatment system as claimed in one of the above-described exemplary embodiments. In conjunction with the internal combustion engine, the advantages, in particular, which have already been described in conjunction with the method and with the exhaust gas aftertreatment system result.

The internal combustion engine preferably has an exhaust gas turbocharger with an exhaust gas turbocharger turbine in an exhaust gas path of the exhaust gas aftertreatment system (preferably upstream of the SCR catalytic converter) and an exhaust gas turbocharger compressor in a charge path of the internal combustion engine, the exhaust gas turbocharger turbine preferably being assigned a bypass path and a turbine bypass path actuating device, the exhaust gas turbocharger compressor preferably being assigned a bypass path and a compressor bypass path actuating device, the control device of the exhaust gas aftertreatment system preferably being operatively connected to the turbine bypass path actuating device and/or to the compressor bypass path actuating device in order to actuate them/it.

The internal combustion engine preferably has an exhaust gas recirculation device which is set up for the recirculation of exhaust gas into a combustion chamber of the internal combustion engine, the control device of the exhaust gas aftertreatment system preferably being operatively connected to the exhaust gas recirculation device in order to set an exhaust gas recirculation rate. Moreover, the control device is preferably set up to set a location of the center of combustion in the at least one combustion chamber of the internal combustion engine, particularly preferably by way of variation of an ignition time.

It is possible that the control device of the exhaust gas aftertreatment system is a control unit of the internal combustion engine, in particular an engine control unit, or that the functionality of the control device of the exhaust gas aftertreatment system is integrated into the control unit, in particular the engine control unit, of the internal combustion engine. It is also possible, however, that the exhaust gas aftertreatment system is assigned a separate control device.

The internal combustion engine is preferably configured as a reciprocating piston engine. It is possible that the internal combustion engine is set up to drive a passenger motor vehicle, a truck or a commercial vehicle. In one preferred exemplary embodiment, the internal combustion engine serves to drive, in particular, heavy land-based or water-borne vehicles, for example mining vehicles or trains, the internal combustion engine being used in a locomotive or a railcar, or ships. A use of the internal combustion engine to drive a vehicle which serves for defense purposes, for example a tank, is also possible. One exemplary embodiment of the internal combustion engine is preferably also used in a stationary manner, for example for the stationary energy supply in emergency power operation, continuous duty operation or peak load operation, the internal combustion engine preferably driving a generator in this case. A stationary application of the internal combustion engine to drive auxiliary units, for example fire extinguishing pumps on oil rigs, is also possible. Furthermore, a use of the internal combustion engine in the field of the conveying of fossil raw materials and, in particular fuels, for example oil and/or gas, is also possible. A use of the internal combustion engine in the industrial field or in the construction field, for example in a construction machine or building machine, for example in a crane or an excavator, is also possible. The internal combustion engine is preferably configured as a diesel engine, as a gasoline engine, as a gas engine for operating with natural gas, biogas, special gas or another suitable gas. If, in particular, the internal combustion engine is configured as a gas engine, it is suitable for use in a heat and power cogeneration plant for stationary power generation.

The exhaust gas aftertreatment system is preferably set up to carry out a method in accordance with one of the above-described embodiments. The internal combustion engine is preferably likewise set up to carry out at least one of the above-described embodiments of the method.

The invention will be described in greater detail in the following text using the drawing, in which:

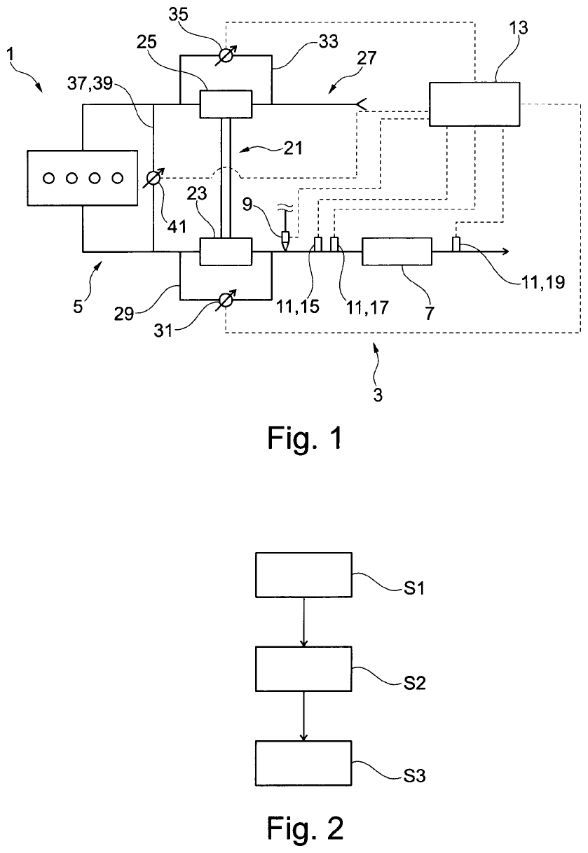

FIG. 1 shows a diagrammatic illustration of one exemplary embodiment of an internal combustion engine having an exhaust gas aftertreatment system, and

FIG. 2 shows a diagrammatic illustration of one embodiment of a method for operating the exhaust gas aftertreatment system and the internal combustion engine according to FIG. 1.

FIG. 1 shows a diagrammatic illustration of one exemplary embodiment of an internal combustion engine 1 having an exhaust gas aftertreatment system 3 which has an exhaust gas path 5, an SCR catalytic converter 7 being arranged in the exhaust gas path 5, which SCR catalytic converter 7 has an SCR catalytic converter material, the exhaust gas aftertreatment system 3 having, moreover, a reducing agent metering device 9 which is set up to meter a reducing agent, in particular ammonia or an ammonia precursor product, in particular a urea/water solution, into the exhaust gas path 5 upstream of the SCR catalytic converter 7. Moreover, the exhaust gas aftertreatment system 3 has at least one detection device 11 (here, a plurality of detection devices 11) for the detection of at least one operating parameter (here, in particular, for the detection of a plurality of operating parameters), the at least one operating parameter being associated with an oxidation state of the SCR catalytic converter material of the SCR catalytic converter 7. Moreover, the exhaust gas aftertreatment system 3 has a control device 13 which is set up to initiate at least one measure for preventing further reduction of the SCR catalytic converter material and/or at least one reoxidation measure for the reoxidation of the SCR catalytic converter material in a manner which is dependent on the at least one operating parameter. In this way, an (in particular, progressing) reduction of a nitrogen oxide conversion rate of the SCR catalytic converter 7 on account of a reduction of the SCR catalytic converter material can be avoided or reversed, in particular by the SCR catalytic converter material being regenerated by way of reoxidation regularly or as required. This ultimately leads to it being possible for a smaller, inexpensive SCR catalytic converter 7 which saves installation space to be used on the internal combustion engine 1, and/or to it being possible for the internal combustion engine 1 to be optimized to a more pronounced extent with regard to a degree of efficiency at the expense of the nitrogen oxide emissions, which involves fuel savings, it nevertheless being possible for limit values for the nitrogen oxide emissions to be complied with, since the SCR catalytic converter 7 has an increased efficiency.

Here, in particular, an exhaust gas temperature sensor 15 and a nitrogen oxide sensor 17 are provided (both in the exhaust gas path 5 upstream of the SCR catalytic converter 7) as detection devices 11 for detecting operating parameters, a reducing agent sensor 19, in particular an ammonia sensor, being arranged in the exhaust gas path 5 downstream of the SCR catalytic converter 7 as a further detection device 11. The control device 13 preferably has an operating time detection means, with the result that an operating time of the exhaust gas aftertreatment system 3 and/or an exhaust gas temperature/operating time integral can be detected by way of the control device 13.

The control device 13 is operatively connected, in particular, to the reducing agent metering device 9 and to the different detection devices 11.

Moreover, the internal combustion engine 1 has an exhaust gas turbocharger 21 which has an exhaust gas turbocharger turbine 23 and an exhaust gas turbocharger compressor 25, the exhaust gas turbocharger compressor 25 being operatively connected in drive terms to the exhaust gas turbocharger turbine 23. Here, the exhaust gas turbocharger turbine 23 is arranged in the exhaust gas path 5 of the internal combustion engine 1, the exhaust gas turbocharger compressor 25 being arranged in a charge path 27 of the internal combustion engine 1.

The exhaust gas turbocharger turbine 23 is assigned a turbine bypass path 29 with a turbine bypass path actuating device 31, via which turbine bypass path 29 a certain proportion of exhaust gas can be conducted around the exhaust gas turbocharger turbine 23 in a manner which is dependent on an actuating position of the turbine bypass path actuating device 31 which can be configured, in particular, as a wastegate.

The exhaust gas turbocharger compressor 25 is assigned a compressor bypass path 33 with a compressor bypass path actuating device 35, it being possible for charge air which flows along the charge path 27 to be conducted past the exhaust gas turbocharger compressor 25 and, in particular, to be returned from a high pressure side of the exhaust gas turbocharger compressor 25 to a low pressure side thereof in a manner which is dependent on an actuating position of the compressor bypass path actuating device 35, which is also called a removal of charge air or bypassing of the exhaust gas turbocharger compressor 25. Here, a proportion of the removed or bypassed charge air can be set by way of a change of the actuating position of the turbine bypass path actuating device 35.

Moreover, the internal combustion engine 1 has an exhaust gas recirculation device 37 (here, in the form of an exhaust gas recirculation path 39), an exhaust gas recirculation actuating device 41 (in particular, in the form of an exhaust gas recirculation flap) being arranged in the exhaust gas recirculation path 39, by means of which exhaust gas recirculation actuating device 41 an exhaust gas recirculation rate (that is to say, a proportion of exhaust gas which is recirculated into the charge path 27 from the exhaust gas path 5) can be set. Here, FIG. 1 shows a high pressure exhaust gas recirculation means by way of example. It is likewise possible, however, that the internal combustion engine 1 has a low pressure exhaust gas recirculation means.

The control device 13 is operatively connected to the turbine bypass path actuating device 31, the compressor bypass path actuating device 35 and the exhaust gas recirculation device 37 (here, in particular, to the exhaust gas recirculation actuating device 41), in order to set their actuating positions.

FIG. 2 shows a diagrammatic illustration of one embodiment of a method for operating an exhaust gas aftertreatment system of an internal combustion engine, in particular for operating the exhaust gas aftertreatment system 3 of the internal combustion engine 1 according to FIG. 1. Here, in a first step S1, at least one operating parameter is detected during operation of the exhaust gas aftertreatment system 3, which operating parameter is associated with an oxidation state of an SCR catalytic converter material of the SCR catalytic converter 7.

In a second step S2, the at least one detected operating parameter is evaluated, in particular with regard to the oxidation state of the SCR catalytic converter material.

In a third step S3, at least one measure for preventing further reduction of the SCR catalytic converter material and/or at least one reoxidation measure for the reoxidation of the SCR catalytic converter material are/is initiated in a manner which is dependent on the at least one operating parameter, in particular in a manner which is dependent on the oxidation state of the SCR catalytic converter material which has been determined using the at least one operating parameter in the second step S2.

Here, an exhaust gas temperature, an operating time, an exhaust gas temperature/operating time integral, a temporally integrally converted nitrogen oxide load, a temporally integrally metered reducing agent quantity, a nitrogen oxide concentration and/or a reducing agent concentration downstream of the SCR catalytic converter 7 in the exhaust gas aftertreatment system 3 are/is preferably detected as the at least one operating parameter.

The at least one operating parameter is compared with a predefined threshold value which is preferably stored in the control device 13, the measure for preventing further reduction and/or the reoxidation measure being initiated if the at least one operating parameter reaches or exceeds the predefined threshold value, or if the at least one operating parameter reaches or exceeds the predefined threshold value for a predefined time duration.

A catalytic converter reaction model is preferably stored in the control device 13, the oxidation state of the SCR catalytic converter material and/or a nitrogen oxide conversion value of the SCR catalytic converter material being determined by means of the catalytic converter reaction model, the catalytic converter reaction model being fed the at least one operating parameter as an input variable, the at least one measure for preventing further reduction and/or the at least one reoxidation measure being initiated in a manner which is dependent on the nitrogen oxide conversion value and/or the oxidation state which is determined by way of the catalytic converter reaction model.

Preferably, metering of a reducing agent into the exhaust gas path 5 of the exhaust gas aftertreatment system 3 upstream of the SCR catalytic converter 7 is reduced, an oxygen concentration in the exhaust gas upstream of the SCR catalytic converter 7 is raised, the exhaust gas temperature upstream of the SCR catalytic converter 7 is lowered, and/or a nitrogen oxide concentration in the exhaust gas upstream of the SCR catalytic converter 7 is reduced as the at least one measure for preventing further reduction and/or the at least one reoxidation measure.

The oxygen concentration is preferably raised and/or the exhaust gas temperature is lowered, by the actuating position of the turbine bypass path actuating device 31 being changed, and/or by the actuating position of the compressor bypass path actuating device 35 being changed.

The nitrogen oxide concentration in the exhaust gas is preferably reduced, by the exhaust gas recirculation rate being increased, in particular, by means of the exhaust gas recirculation actuating device 41, and/or by a location of the center of combustion being changed in at least one combustion chamber of the internal combustion engine 1. To this end, the control device 13 is preferably operatively connected to an ignition device or an injector for the direct injection of fuel into the combustion chamber, in order for it to be possible for an ignition time to be set.

It is shown overall that an increase or regeneration of a nitrogen oxide conversion rate on an SCR catalytic converter 7 is achieved, or its further reduction can at least be prevented, by way of the method which is proposed here, by way of the exhaust gas aftertreatment system 3 which is proposed here and by way of the internal combustion engine 1 which is proposed here, with the result that the SCR catalytic converter 7 can be of smaller, less expensive and installation space-saving configuration, and/or that the internal combustion engine 1 can be optimized to a more pronounced extent with regard to a degree of efficiency and therefore in a fuel-saving manner, whereby associated, higher nitrogen oxide emissions are therefore compensated by way of the higher or at least non-reduced conversion rate of the SCR catalytic converter 7.

1-11. (canceled)

12. A method for operating an exhaust gas aftertreatment system of an internal combustion engine, comprising the steps of:
detecting at least one operating parameter during operation of the exhaust gas aftertreatment system, which operating parameter is associated with an oxidation state of an SCR catalytic converter material of the exhaust gas aftertreatment system; and
initiating at least one measure for preventing a progressing reduction of the SCR catalytic converter material and/or at least one reoxidation measure for reoxidation of the SCR catalytic converter material dependent on the at least one operating parameter.

13. The method according to claim 12, including carrying out the at least one measure for preventing a progressing reduction of the SCR catalytic converter material and/or the at least one reoxidation measure for the reoxidation of the SCR catalytic converter material immediately after the initiation.

14. The method according to claim 12, including carrying out the at least one measure for preventing a progressing reduction of the SCR catalytic converter material and/or the at least one reoxidation measure for the reoxidation of the SCR catalytic converter material in a temporally delayed manner after the initiation.

15. The method according to claim 12, including detecting:
an exhaust gas temperature;
an operating time;
an exhaust gas temperature/operating time integral;
a temporally integrally converted nitrogen oxide load;
a temporally integrally metered reducing agent quantity, and/or
a nitrogen oxide concentration and/or reducing agent concentration downstream of the SCR catalytic converter material in the exhaust gas aftertreatment system as the at least one operating parameter.

16. The method according to claim 12, further including comparing the at least one operating parameter with a predefined threshold value, and initiating the at least one measure for preventing a progressing reduction of the SCR catalytic converter material and/or the at least one reoxidation measure if
a) the at least one operating parameter reaches or exceeds the predefined threshold value, or
b) the at least one operating parameter reaches or exceeds the predefined threshold value for a predefined time duration.

17. The method according to claim 12, further including determining the oxidation state of the SCR catalytic converter material and/or a nitrogen oxide conversion quantity of the SCR catalytic converter material by a catalytic converter reaction model, the catalytic converter reaction model being fed the at least one operating parameter as an input variable, the at least one measure for preventing a progressing reduction of the SCR catalytic converter material and/or the at least one reoxidation measure being initiated in a manner dependent on the nitrogen oxide conversion quantity and/or the oxidation state determined by the catalytic converter reaction model.

18. The method according to claim 12, further including
reducing metering of a reducing agent into an exhaust gas path of the exhaust gas aftertreatment system upstream of the SCR catalytic converter material,
raising an oxygen concentration in the exhaust gas upstream of the SCR catalytic converter material,
reducing a nitrogen oxide concentration in the exhaust gas upstream of the SCR catalytic converter material, and/or
reducing an exhaust gas temperature upstream of the SCR catalytic converter material as the at least one reoxidation measure and/or as the at least one measure for preventing a progressing reduction of the SCR catalytic converter material.

19. The method according to claim 12, including raising oxygen concentration in an exhaust gas upstream of the SCR catalytic converter material and/or reducing exhaust gas temperature upstream of the SCR catalytic converter material, wherein
an actuating position of a turbine bypass path actuating device for a bypass path of an exhaust gas turbocharger turbine upstream of the SCR catalytic converter material is changed, and/or
an actuating position of a compressor bypass path actuating device for a bypass path of an exhaust gas turbocharger compressor is changed.

20. The method according to claim 18, wherein the nitrogen oxide concentration in the exhaust gas upstream of the SCR catalytic converter material is reduced, by
increasing an exhaust gas recirculation rate for recirculation of exhaust gas into a combustion chamber of an Internal combustion engine assigned to the exhaust gas aftertreatment system, and/or
charging a location of a center of combustion in the combustion chamber of the internal combustion engine assigned to the exhaust gas aftertreatment system.

21. An exhaust gas aftertreatment system for an internal combustion engine, comprising:
an exhaust gas path;
an SCR catalytic converter in the exhaust gas path;
a reducing agent metering device for metering reducing agent into the exhaust gas path upstream of the SCR catalytic converter; and
at least one detection device for detecting at least one operating parameter associated with an oxidation state of an SCR catalytic converter material of the SCR catalytic converter, the detection device including a control device operatively configured to initiate at least one measure for preventing a progressing reduction of the SCR catalytic converter material and/or at least one reoxidation measure for reoxidation of the SCR catalytic converter material dependent on the at least one detected operating parameter.

22. An internal combustion engine, having an exhaust gas aftertreatment system according to claim 21.
